(19) United States
(12) Patent Application Publication
(10) Pub. No.: US 2026/0332964 A1
(43) Pub. Date: Oct. 22, 2026

(54) ULTRASONIC TRANSDUCER

(71) Applicant: Murata Manufacturing Co., Ltd., Nagaokakyo-shi (JP)

(72) Inventors: Seiji UMEZAWA, Nagaokakyo-shi (JP); Yasuhiro AIDA, Nagaokakyo-shi (JP); Ryosuke NIWA, Nagaokakyo-shi (JP); Shinsuke IKEUCHI, Nagaokakyo-shi (JP); Hiroshi MATSUBARA, Nagaokakyo-shi (JP)

(21) Appl. No.: 19/700,742

(22) Filed: Jun. 8, 2026

Related U.S. Application Data
(63) Continuation of application No. PCT/JP2024/034122, filed on Sep. 25, 2024.

(30) Foreign Application Priority Data
Feb. 13, 2024 (JP) 2024-019350
Jun. 17, 2024 (JP) 2024-097493

(51) Int. Cl. H04R 19/00

(52) U.S. Cl. CPC H04R 19/00; H04R 2201/003

(57) ABSTRACT

An ultrasonic transducer includes an acoustic MEMS element and an acoustic path. The acoustic path is coupled with the acoustic MEMS element. Ultrasound generated by the vibration of the acoustic MEMS element can resonate in the acoustic path. The sound pressure frequency characteristics of the ultrasonic transducer include multiple sound pressure peaks due to the combination of the resonance of the acoustic MEMS element and the resonance in the acoustic path. The resonant frequency of the acoustic MEMS element (f0) and the resonant frequency of the acoustic path (f1) satisfy the relationship of −20≤(f1−f0)/f0×100≤80.

### CROSS REFERENCE TO RELATED APPLICATIONS

This application is a continuation of International Application No. PCT/JP2024/034122, filed Sep. 25, 2024, which claims priority to Japanese Patent Application No. 2024-097493, filed Jun. 17, 2024, and Japanese Patent Application No. 2024-019350, filed Feb. 13, 2024, the entire contents of each of which are hereby incorporated by reference in their entirety.

### TECHNICAL FIELD

The present disclosure relates to an ultrasonic transducer.

### BACKGROUND

In a related example, International Publication No. 2020/230484 discloses configurations of an ultrasonic transducer. The ultrasonic transducer includes a mounting substrate and a piezoelectric device. The piezoelectric device is mounted on the mounting substrate. The piezoelectric device includes a substrate, a piezoelectric element, and a cover. A through hole is formed in the substrate. The piezoelectric element is located on a first main surface of the substrate. The mounting substrate faces a second main surface of the substrate. A through hole is formed in the mounting substrate. The end of the through hole in the mounting substrate on the piezoelectric device side is located at a position facing the through hole in the substrate.

### SUMMARY

In ultrasonic transducers, the Q value in the frequency band can be reduced in some examples, so that ultrasound with a stable phase in that frequency band can be emitted.

Accordingly, some exemplary aspects of the present disclosure provide an ultrasonic transducer that includes an acoustic MEMS element and an acoustic path. In an exemplary aspect, the acoustic path communicates with the acoustic MEMS element. For example, the acoustic path is coupled (e.g., acoustically coupled) to the acoustic MEMS element. Ultrasound generated by vibration of the acoustic MEMS element can resonate in the acoustic path. The sound pressure frequency characteristics of the ultrasonic transducer include multiple sound pressure peaks due to a combination of resonance of the acoustic MEMS element and resonance in the acoustic path. A resonant frequency (also referred to as a first resonant frequency) of the acoustic MEMS element (f0) and a resonant frequency (also referred to as a second resonant frequency) of the acoustic path (f1) satisfy a relationship of −20≤(f1−f0)/f0×100≤80.

According to technical effects of the present disclosure, the Q value in the frequency band that is used can be reduced, enabling ultrasound with a stable phase in that frequency band to be emitted.

### BRIEF DESCRIPTION OF DRAWINGS

FIG. 1 is a perspective view illustrating the external appearance of an acoustic MEMS element included in an ultrasonic transducer according to Exemplary Embodiment 1 of the present disclosure.

FIG. 2 is a cross-sectional view of the acoustic MEMS element in FIG. 1 taken along line II-II viewed in the direction of the arrows.

FIG. 3 is a cross-sectional view illustrating a state in which a second electrode layer is provided on a piezoelectric single crystal substrate in a method for manufacturing an acoustic MEMS element according to Exemplary Embodiment 1 of the present disclosure.

FIG. 4 is a cross-sectional view illustrating a state in which a first support portion is provided in the method for manufacturing an acoustic MEMS element according to Exemplary Embodiment 1 of the present disclosure.

FIG. 5 is a cross-sectional view illustrating a state in which a multilayer body is bonded to the first support portion in the method for manufacturing an acoustic MEMS element according to Exemplary Embodiment 1 of the present disclosure.

FIG. 6 is a cross-sectional view illustrating a state in which a piezoelectric single crystal substrate has been cut to form a piezoelectric layer in the method for manufacturing an acoustic MEMS element according to Exemplary Embodiment 1 of the present disclosure.

FIG. 7 is a cross-sectional view illustrating a state in which a first electrode layer is provided on the piezoelectric layer in the method for manufacturing an acoustic MEMS element according to Exemplary Embodiment 1 of the present disclosure.

FIG. 8 is a cross-sectional view illustrating a state in which a groove and a recess are provided in the method for manufacturing an acoustic MEMS element according to Exemplary Embodiment 1 of the present disclosure.

FIG. 9 is a cross-sectional view illustrating a state in which a first connecting electrode layer and a second electrode connecting layer are provided in the method for manufacturing an acoustic MEMS element according to Exemplary Embodiment 1 of the present disclosure.

FIG. 10 is a plan view illustrating the ultrasonic transducer according to Exemplary Embodiment 1 of the present disclosure.

FIG. 11 is a cross-sectional view of the ultrasonic transducer in FIG. 10 taken along line XI-XI viewed in the direction of the arrows.

FIG. 12 is a graph illustrating changes in sound pressure and phase with respect to frequency of ultrasound emitted from a single acoustic MEMS element.

FIG. 13 is a graph illustrating changes in sound pressure and phase with respect to frequency in the acoustic path of ultrasound emitted from a virtual sound source disposed at the location of a membrane portion.

FIG. 14 is a graph illustrating changes in phase with respect to frequency of ultrasound emitted from ultrasonic transducers constructed by combining acoustic paths of samples 1 to 4 with a single acoustic MEMS element.

FIG. 15 is a graph illustrating changes in sound pressure with respect to frequency of ultrasound emitted from ultrasonic transducers constructed by combining the acoustic paths of samples 1 to 4 with a single acoustic MEMS element.

FIG. 16 is a graph illustrating the rate of change of phase θ with respect to frequency f in the phase frequency characteristics of ultrasound emitted from ultrasonic transducers constructed by combining the acoustic paths of samples 1 to 5 with a single acoustic MEMS element.

FIG. 17 is a graph illustrating the relationship between dθ/df and the resonant frequency of the acoustic path when the resonant frequency of the acoustic MEMS element is 40 kHz.

FIG. 18 is a cross-sectional view illustrating an ultrasonic transducer of a First Modification of Exemplary Embodiment 1 in which a cavity constituting an acoustic path is formed in a plurality of stacked substrates.

FIG. 19 is a cross-sectional view illustrating an ultrasonic transducer of a Second Modification of Exemplary Embodiment 1 in which the cavity constituting the acoustic path does not penetrate through the substrate.

FIG. 20 is a cross-sectional view illustrating an ultrasonic transducer according to Exemplary Embodiment 2 of the present disclosure.

FIG. 21 is a cross-sectional view illustrating an ultrasonic transducer of a modification of Exemplary Embodiment 2 in which the cavity constituting the acoustic path does not penetrate through the substrate.

### DETAILED DESCRIPTION OF EMBODIMENTS

Hereinafter, ultrasonic transducers according to exemplary embodiments of the present disclosure will be described with reference to the drawings. In the following description of exemplary embodiments, the same or corresponding parts in the figures will be denoted by the same reference symbols, and description thereof will not be repeated.

In this specification, “MEMS” is an abbreviation of Micro Electro Mechanical Systems. “Acoustic MEMS elements” can be a general term representing any of MEMS microphones, pMUTs (piezoelectric micro-machined ultrasonic transducers), cMUTs (capacitive micro-machined ultrasonic transducers), MEMS speakers, and so on.

### Exemplary Embodiment 1

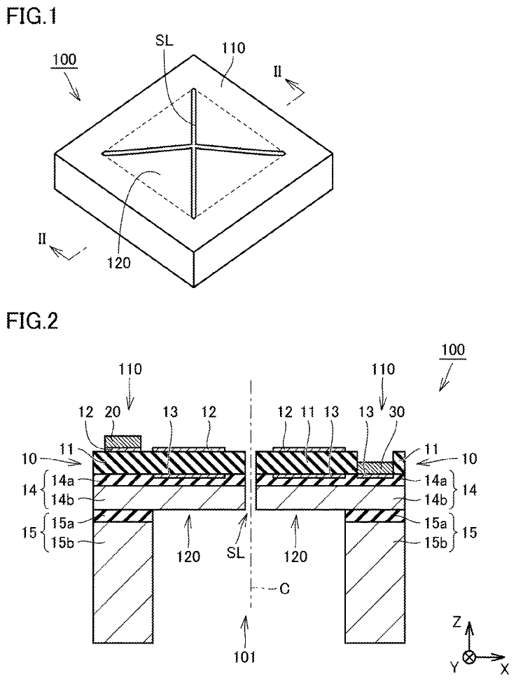

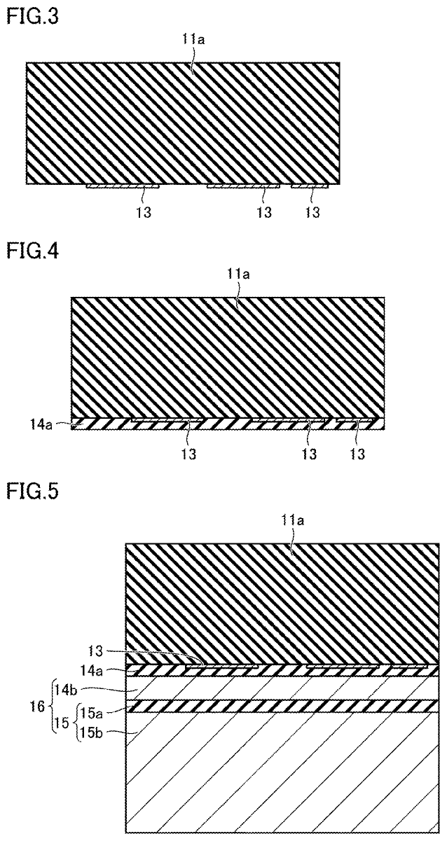

FIG. 1 is a perspective view illustrating the external appearance of an acoustic MEMS element included in an ultrasonic transducer according to Exemplary Embodiment 1 of the present disclosure. FIG. 2 is a cross-sectional view of the acoustic MEMS element in FIG. 1 taken along line II-II viewed in the direction of the arrows.

As illustrated in FIGS. 1 and 2, an acoustic MEMS element 100 includes a base portion 110 and a membrane portion 120. In this exemplary embodiment, the acoustic MEMS element 100 is a piezoelectric element. The membrane portion 120 performs at least one of vibration generation and vibration detection using a piezoelectric material. Note that the acoustic MEMS element 100 is not limited to a piezoelectric element, and may be configured to perform at least one of vibration generation and vibration detection using an electrostatic method.

In this exemplary embodiment, the base portion 110 has a square annular shape that extends in X-axis and Y-axis directions when viewed in an axial direction of a central axis C illustrated in FIG. 2. The shape of the base portion 110 is not particularly limited as long as it is an annular shape when viewed in the central axis direction (Z-axis direction). When viewed in the central axis direction (Z-axis direction), the outer peripheral surface of the base portion 110 may be polygonal or circular, and the inner peripheral surface of the base portion 110 may also be polygonal or circular. For example, the length of one side of the inner peripheral surface of the base portion 110 is 0.6 mm or more and 1.5 mm or less, and the thickness of the base portion 110 is 0.2 mm or more and 0.5 mm or less.

As illustrated in FIG. 2, the base portion 110 includes a support layer 15. An opening 101 is formed in the support layer 15. A vibration layer 10 is disposed above the support layer 15. The base portion 110 further includes a portion of the vibration layer 10 located above the support layer 15, and a first connecting electrode layer 20 and a second connecting electrode layer 30 disposed above that portion of the vibration layer 10.

The support layer 15 includes an intermediate layer 15a and a substrate layer 15b. The intermediate layer 15a is formed on the substrate layer 15b. In this exemplary embodiment, the intermediate layer 15a is composed of SiO₂ and the substrate layer 15b is composed of single-crystal Si. Note that the materials constituting the intermediate layer 15a and the substrate layer 15b are not limited to Si, and may be other semiconductor materials.

The vibration layer 10 includes a piezoelectric layer 11, a first electrode layer 12, a second electrode layer 13, and an elastic layer 14. The thickness of the vibration layer 10 is, for example, 0.5 μm or more and 6.0 μm or less.

The piezoelectric layer 11 is composed of a single-crystal piezoelectric material. The cut orientation of the piezoelectric layer 11 is selected as appropriate so that desired device characteristics are exhibited. In this exemplary embodiment, the piezoelectric layer 11 is a thinned single-crystal substrate, and the single-crystal substrate is a rotated Y-cut substrate in an example. The cut orientation of the rotated Y-cut substrate is 30° in an example. The thickness of the piezoelectric layer 11 is, for example, 0.3 μm or more and 5.0 μm or less.

The material constituting the piezoelectric layer 11 is appropriately selected so that the acoustic MEMS element 100 exhibits desired characteristics. In this exemplary embodiment, the piezoelectric layer 11 is composed of an inorganic material. In some examples, the piezoelectric layer 11 is composed of an alkali niobate compound or an alkali tantalate compound. In this exemplary embodiment, the alkali metal contained in the alkali niobate compound or alkali tantalate compound is at least one of lithium, sodium, and potassium. In this exemplary embodiment, the piezoelectric layer 11 is composed of lithium niobate (LiNbO₃) or lithium tantalate (LiTaO₃).

As illustrated in FIG. 2, the first electrode layer 12 is disposed above the piezoelectric layer 11. The second electrode layer 13 is disposed below the piezoelectric layer 11 so as to face at least a portion of the first electrode layer 12 with the piezoelectric layer 11 therebetween. In this exemplary embodiment, an adhesion layer, which is not illustrated, is provided between the first electrode layer 12 and the piezoelectric layer 11, and between the second electrode layer 13 and the piezoelectric layer 11.

In this exemplary embodiment, the first electrode layer 12 and the second electrode layer 13 are each composed of Pt. The first electrode layer 12 and the second electrode layer 13 may each be composed of another material such as Al. The adhesion layer is composed of Ti. The adhesion layer may be composed of another material such as a NiCr alloy. Each of the first electrode layer 12, the second electrode layer 13 and the adhesion layers may be an epitaxially grown film. When the piezoelectric layer 11 is composed of lithium niobate (LiNbO₃), it is preferable that the adhesion layer be composed of a NiCr alloy from the viewpoint of suppressing diffusion of the material constituting the adhesion layers into the first electrode layer 12 or the second electrode layer 13. This enables the reliability of the acoustic MEMS element 100 to be improved.

In this exemplary embodiment, the dimensions of each of the first electrode layer 12 and the second electrode layer 13 are, for example, 0.05 μm or more and 0.2 μm or less. The thickness of the adhesion layers is, for example, 0.005 μm or more and 0.05 μm or less.

The elastic layer 14 is disposed on the side of the piezoelectric layer 11 on the opposite side from the first electrode layer 12, and on the side of the second electrode layer 13 on the opposite side from the piezoelectric layer 11. The elastic layer 14 includes a first elastic layer 14a and a second elastic layer 14b stacked on the side of the first elastic layer 14a on the opposite side from the piezoelectric layer 11. In this exemplary embodiment, the first elastic layer 14a is composed of SiO₂, and the second elastic layer 14b is composed of single-crystal Si. In this exemplary embodiment, the thickness of the elastic layer 14 is preferably greater than that of the piezoelectric layer 11 from the viewpoint of bending vibration of the membrane portion 120.

Furthermore, if the second elastic layer 14b is composed of low-resistance Si, it becomes possible to use the second elastic layer 14b as the lower electrode layer without providing the second electrode layer 13, in which case the first elastic layer 14a is not provided.

As illustrated in FIG. 2, the first connecting electrode layer 20 is formed on the first electrode layer 12 with an adhesion layer, which is not illustrated, therebetween. The second connecting electrode layer 30 is formed on the second electrode layer 13 with an adhesion layer, which is not illustrated, therebetween.

The thickness of each of the first connecting electrode layer 20 and the second connecting electrode layer 30 is, for example, 0.1 μm or more and 1.0 μm or less. The thickness of the adhesion layer connected to the first connecting electrode layer 20 and the adhesion layer connected to the second connecting electrode layer 30 is, for example, 0.005 μm or more and 0.1 μm or less.

In this exemplary embodiment, the first connecting electrode layer 20 and the second connecting electrode layer 30 are each composed of Au. The first connecting electrode layer 20 and the second connecting electrode layer 30 may also be composed of other conductive materials such as Al. The adhesion layer connected to the first connecting electrode layer 20 and the adhesion layer connected to the second connecting electrode layer 30 are each composed of, for example, Ti. These adhesion layers may also be composed of a NiCr alloy.

As illustrated in FIGS. 1 and 2, a slit SL is formed in the vibration layer 10 in a portion located inside the base portion 110 when viewed in the central axis direction (Z axis direction). From the viewpoint of suppressing sound leakage, the width of the slit SL is preferably 10 μm or less. In addition, from the viewpoint of lowering the Q value at the resonant frequency of the acoustic MEMS element 100, it may be preferable for the slit SL to have a width of 3 μm or more.

As illustrated in FIG. 2, the membrane portion 120 is positioned to cover the opening 101. The membrane portion 120 extends along a virtual plane when the acoustic MEMS element 100 is not operating. The membrane portion 120 is a vibrating portion that includes the piezoelectric layer 11.

The membrane portion 120 is configured to vibrate when a voltage is applied to the piezoelectric layer 11. Furthermore, vibrations acting on the membrane portion 120 are converted into a voltage by the piezoelectric layer 11, thereby allowing detection of the vibrations. Note that the membrane portion 120 is not limited to being configured to generate and detect vibrations using a piezoelectric method as described above, and may also be configured to generate and detect vibrations using an electrostatic method.

From the viewpoint of facilitating bending vibration, the length of the membrane portion 120 in the extending direction thereof is preferably at least 5 times the thickness of the membrane portion 120 in the central axis direction (Z axis direction). Note that in FIG. 2, the extending length and thickness of the membrane portion 120 are illustrated schematically and do not represent the actual ratio.

When generating ultrasound using the acoustic MEMS element 100, a voltage is applied between the first connecting electrode layer 20 and the second connecting electrode layer 30, as illustrated in FIG. 2. A voltage is applied between the first electrode layer 12 connected to the first connecting electrode layer 20 and the second electrode layer 13 connected to the second connecting electrode layer 30. Furthermore, in the membrane portion 120, a voltage is also applied between the first electrode layer 12 and the second electrode layer 13, which face each other with the piezoelectric layer 11 therebetween. As a result, the piezoelectric layer 11 expands and contracts along an in-plane direction perpendicular to the thickness direction (Z-axis direction), causing the membrane portion 120 to undergo bending vibration along the thickness direction (Z-axis direction). Thus, a force is applied to the medium surrounding the membrane portion 120 of the acoustic MEMS element 100, and the resulting vibration of the medium generates ultrasound.

Furthermore, in the acoustic MEMS element 100 according to this exemplary embodiment, the membrane portion 120 has an intrinsic mechanical resonant frequency. Therefore, when the applied voltage is a sinusoidal voltage and the frequency of the sinusoidal voltage is close to the value of the resonant frequency, the amount of displacement when the membrane portion 120 bends is large.

When the acoustic MEMS element 100 is to detect ultrasound, the ultrasound causes the medium surrounding the membrane portion 120 to vibrate, and a force is applied to the membrane portion 120 from the surrounding medium, causing the membrane portion 120 to undergo bending vibration. When the membrane portion 120 undergoes bending vibration, stress is applied to the piezoelectric layer 11. This stress acting on the piezoelectric layer 11 induces electric charge in the piezoelectric layer 11. The electric charge induced in the piezoelectric layer 11 generates a potential difference between the first electrode layer 12 and second electrode layer 13, which face each other across the piezoelectric layer 11. This potential difference is detected by the first connecting electrode layer 20 connected to the first electrode layer 12 and the second connecting electrode layer 30 connected to the second electrode layer 13. This enables the acoustic MEMS element 100 to detect ultrasound.

Furthermore, if the ultrasound to be detected contains a large amount of a specific frequency component, and this frequency component is close to the value of the resonant frequency, the amount of displacement that occurs when the membrane portion 120 undergoes bending vibration will be large. This large amount of displacement will result in a large potential difference.

Thus, when the acoustic MEMS element 100 according to this exemplary embodiment is used as an ultrasonic transducer such as a non-contact haptics device, the resonant frequency of the membrane portion 120 is set to 20 kHz or more and 60 kHz or less, for example, 40 kHz. When the acoustic MEMS element 100 is used as an audio device such as a speaker or microphone, the resonant frequency of the membrane portion 120 is set to less than 20 kHz, which is within the audible range.

A method for manufacturing the acoustic MEMS element 100 according to Exemplary Embodiment 1 of the present disclosure will now be described. FIG. 3 is a cross-sectional view illustrating a state in which a second electrode layer is provided on a piezoelectric single crystal substrate in the method for manufacturing the acoustic MEMS element according to Exemplary Embodiment 1 of the present disclosure. FIG. 3 and FIGS. 4 to 9 referred to below illustrate the same cross-sectional view as FIG. 2.

As illustrated in FIG. 3, first, an adhesion layer (not illustrated) is provided on the lower surface of a piezoelectric single crystal substrate 11a, and then the second electrode layer 13 is provided on the side of the adhesion layer on the opposite side from the piezoelectric single crystal substrate 11a. The second electrode layer 13 is formed with a desired pattern using a vapor deposition lift-off method. The second electrode layer 13 may also be formed by being laminated over the entire lower surface of the piezoelectric single crystal substrate 11a by sputtering, and then forming the desired pattern by etching. The second electrode layer 13 and the adhesion layer may be grown epitaxially.

FIG. 4 is a cross-sectional view illustrating a state in which a first support portion is provided in the method for manufacturing an acoustic MEMS element according to Exemplary Embodiment 1 of the present disclosure. As illustrated in FIG. 4, the first elastic layer 14a is provided on the lower surfaces of the piezoelectric single crystal substrate 11a and the second electrode layer 13 using a chemical vapor deposition (CVD) method or a physical vapor deposition (PVD) method. Immediately after the first elastic layer 14a is provided, the portion of the lower surface of the first elastic layer 14a that is on the opposite side from the second electrode layer 13 is raised. Therefore, the lower surface of the first elastic layer 14a is flattened by being ground down using chemical mechanical polishing (CMP) or the like.

FIG. 5 is a cross-sectional view illustrating a state in which a multilayer body is bonded to the first support portion in the method for manufacturing an acoustic MEMS element according to Exemplary Embodiment 1 of the present disclosure. As illustrated in FIG. 5, a multilayer body 16 consisting of the second elastic layer 14b and the support layer 15 is bonded to the lower surface of the first elastic layer 14a by surface activation bonding or atomic diffusion bonding. In this exemplary embodiment, the multilayer body 16 is a silicon on insulator (SOI) substrate. Note that the yield for the acoustic MEMS element 100 can be improved by flattening the upper surface of the second elastic layer 14b in advance using CMP or the like. Furthermore, if the second elastic layer 14b is composed of low-resistance Si, it is possible to make the second elastic layer 14b function as a lower electrode layer, in which case the formation of the second electrode layer 13 and the first elastic layer 14a can become unnecessary.

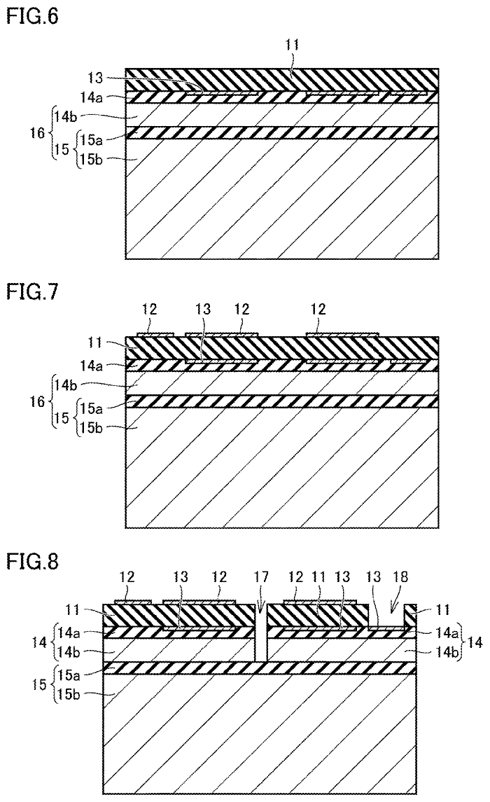

FIG. 6 is a cross-sectional view illustrating a state in which the piezoelectric single crystal substrate has been ground down to form a piezoelectric layer in the method for manufacturing an acoustic MEMS element according to Exemplary Embodiment 1 of the present disclosure. As illustrated in FIG. 6, the upper surface of the piezoelectric single crystal substrate 11a is thinned down by performing grinding with a grinder. The upper surface of the thinned down piezoelectric single crystal substrate 11a is further polished using CMP or the like to form the piezoelectric single crystal substrate 11a into the piezoelectric layer 11.

Alternatively, a peel-off layer may be formed on the upper surface side of the piezoelectric single crystal substrate 11a by implanting ions in advance, and the piezoelectric single crystal substrate 11a may be formed into the piezoelectric layer 11 by peeling off the peel-off layer. Alternatively, the piezoelectric single crystal substrate 11a may be formed into the piezoelectric layer 11 by further polishing the upper surface of the piezoelectric single crystal substrate 11a using CMP or the like after the peel-off layer has been peeled off.

FIG. 7 is a cross-sectional view illustrating a state in which a first electrode layer is provided on the piezoelectric layer in the method for manufacturing an acoustic MEMS element according to Exemplary Embodiment 1 of the present disclosure. As illustrated in FIG. 7, after providing an adhesion layer, which is not illustrated, on the upper surface of the piezoelectric layer 11, the first electrode layer 12 is provided on the opposite side of the adhesion layer from the piezoelectric layer 11. The first electrode layer 12 is formed to have a desired pattern using a vapor deposition lift-off method. The first electrode layer 12 may also be formed by laminating it across the entire upper surface of the piezoelectric layer 11 by sputtering, and then forming a desired pattern using an etching method. The first electrode layer 12 and the adhesion layer may be grown epitaxially.

FIG. 8 is a cross-sectional view illustrating a state in which a groove and a recess are provided in the method for manufacturing an acoustic MEMS element according to Exemplary Embodiment 1 of the present disclosure. As illustrated in FIG. 8, a slit is formed in the piezoelectric layer 11 and the first elastic layer 14a by performing dry etching with reactive ion etching (RIE) or the like in the region corresponding to the area inside the base portion 110 of the acoustic MEMS element 100 when viewed in the stacking direction. The slit may also be formed by performing wet etching using hydrofluoric acid or the like. Furthermore, the second elastic layer 14b exposed in the slit is etched with deep reactive ion etching (DRIE) so that the slit extends to the upper surface of the support layer 15. As a result, a groove 17 illustrated in FIG. 8, which corresponds to the slit SL illustrated in FIGS. 1 and 2, is formed.

Furthermore, as illustrated in FIG. 8, in the portion corresponding to the base portion 110 of the acoustic MEMS element 100, the piezoelectric layer 11 is etched using the dry etching or wet etching method described above so that a portion of the second electrode layer 13 is exposed. In this way, a recess 18 is formed.

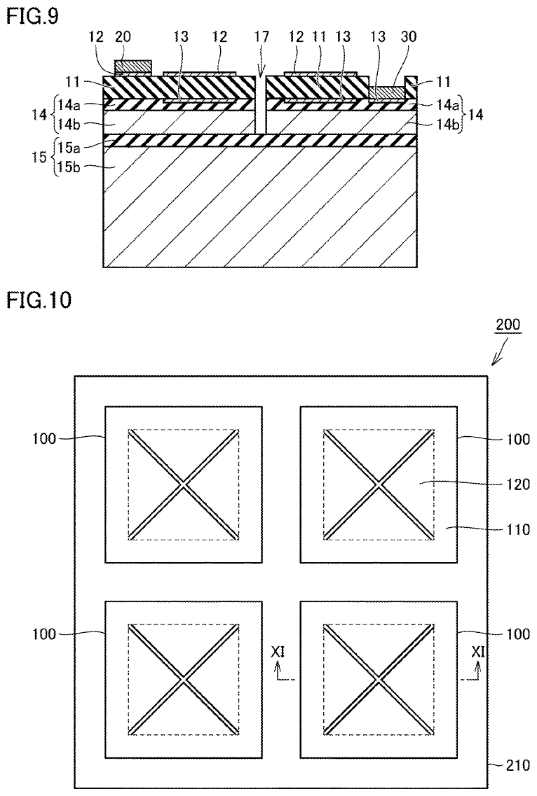

FIG. 9 is a cross-sectional view illustrating a state in which the first connecting electrode layer and the second connecting electrode layer are provided in the method for manufacturing an acoustic MEMS element according to Exemplary Embodiment 1 of the present disclosure. As illustrated in FIG. 9, in the portion corresponding to the base portion 110, an adhesion layer, which is not illustrated, is provided on each of the first electrode layer 12 and the second electrode layer 13, and then the first connecting electrode layer 20 and the second connecting electrode layer 30 are provided on the upper surface of each adhesion layer using a vapor deposition lift-off method. The first connecting electrode layer 20 and the second connecting electrode layer 30 may be formed by performing sputtering to laminate the entire surface of the piezoelectric layer 11, the first electrode layer 12 and the exposed second electrode layer 13, and then forming the desired patterns using an etching method.

Finally, a portion of the substrate layer 15b of the support layer 15 is removed by DRIE, and then a portion of the intermediate layer 15a is removed by RIE. As a result, the opening 101 is provided and the membrane portion 120 is formed, as illustrated in FIG. 2. Through the above process, the acoustic MEMS element 100 according to Exemplary Embodiment 1 of the present disclosure, as illustrated in FIGS. 1 and 2, is manufactured.

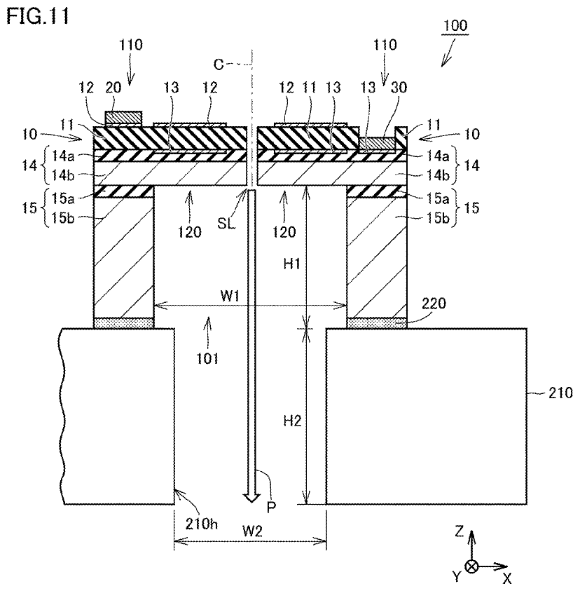

FIG. 10 is a plan view illustrating an ultrasonic transducer according to Exemplary Embodiment 1 of the present disclosure. FIG. 11 is a cross-sectional view of the ultrasonic transducer of FIG. 10 taken along line XI-XI viewed in the direction of the arrows. As illustrated in FIGS. 10 and 11, an ultrasonic transducer 200 according to Exemplary Embodiment 1 of the present disclosure includes the acoustic MEMS element 100 and an acoustic path P. The acoustic path P communicates with the acoustic MEMS element 100. In this exemplary embodiment, the acoustic path P is composed of the opening 101 of the acoustic MEMS element 100 and a cavity 210h formed in a substrate 210.

In some examples, the acoustic MEMS element 100 is mounted on the substrate 210. In this exemplary embodiment, multiple acoustic MEMS elements 100 are disposed in an array on the substrate 210. The frequencies of the ultrasound emitted from each of the multiple acoustic MEMS elements 100 may be different from each other. However, only one acoustic MEMS element 100 may be disposed on the substrate 210. The acoustic MEMS element 100 is fixed to the main surface of the substrate 210 using a die bond agent 220. The die bond agent 220 is a thermosetting adhesive.

The cavities 210h constituting the acoustic paths P are formed in the substrate 210 at positions facing the acoustic MEMS elements 100. In this exemplary embodiment, multiple cavities 210h are formed in the substrate 210 in a one-to-one correspondence with the multiple acoustic MEMS elements 100. The cavities 210h are holes that penetrate through the substrate 210. Each cavity 210h has a cylindrical shape. However, the cavities 210h are not limited to a cylindrical shape, and may have a rectangular parallelepiped shape or the like.

A thickness H2 of the substrate 210 is greater than a shortest distance H1 from the substrate 210 to the membrane portion 120. A diameter W2 of each cavity 210h is smaller than a width W1 of the opening 101.

The material of the substrate 210 is a material made by combining a resin such as glass epoxy with glass fibers, low-temperature co-fired ceramics (LTCC), or ceramics containing alumina or the like. The substrate 210 may also be a flexible substrate composed of copper foil, polyimide, or the like, or a composite substrate provided with a reinforcing plate.

The acoustic path P has a frequency response to ultrasound and resonates at a specific natural frequency. That is, the acoustic path P has a resonant frequency. The ultrasound generated by the vibration of the acoustic MEMS element 100 can resonate in the acoustic path P. On the other hand, as described above, the acoustic MEMS element 100 has an intrinsic resonant frequency of the membrane portion 120.

Next, we will explain the mechanism by which the ultrasonic transducer 200 according to Exemplary Embodiment 1 of the present disclosure realizes a reduced Q value in the frequency band used, thereby enabling the emission of ultrasound with a stable phase in that frequency band.

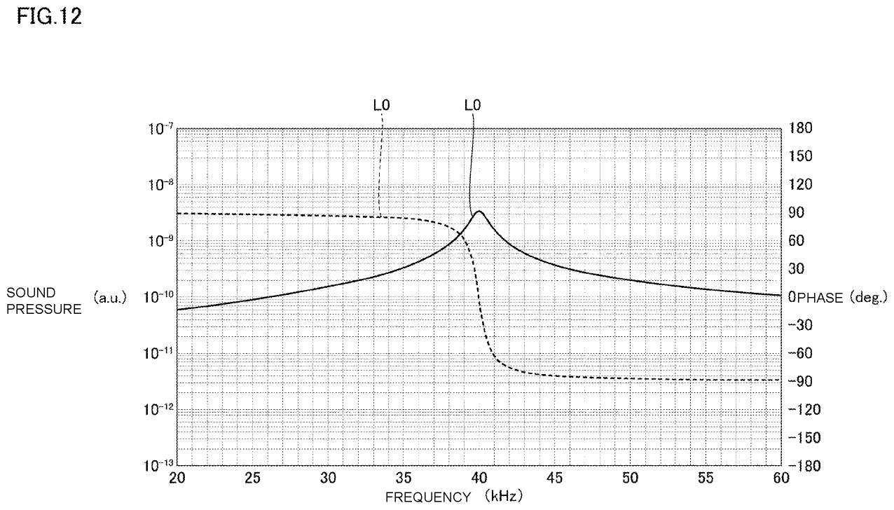

FIG. 12 is a graph illustrating changes in sound pressure and phase with respect to frequency of ultrasound emitted from a single acoustic MEMS element. In FIG. 12, the left vertical axis represents the sound pressure (a.u.) of the ultrasound, the right vertical axis represents the phase of the ultrasound (deg), and the horizontal axis represents the frequency (kHz) of the ultrasound. A solid line L0 represents the sound pressure frequency characteristics, which are the changes in sound pressure with respect to frequency of ultrasound, and a dotted line L0 represents the phase frequency response, which is the change in phase with respect to frequency of ultrasound.

As illustrated in FIG. 12, the sound pressure of the ultrasound emitted from a single acoustic MEMS element 100 peaks at 40 kHz, which is the resonant frequency of the acoustic MEMS element 100. The phase of the ultrasound emitted from the acoustic MEMS element 100 inverts at a frequency of 40 kHz. That is, in the vicinity of the resonant frequency of 40 kHz, the phase of the ultrasound emitted from the acoustic MEMS element 100 undergoes a sudden shift.

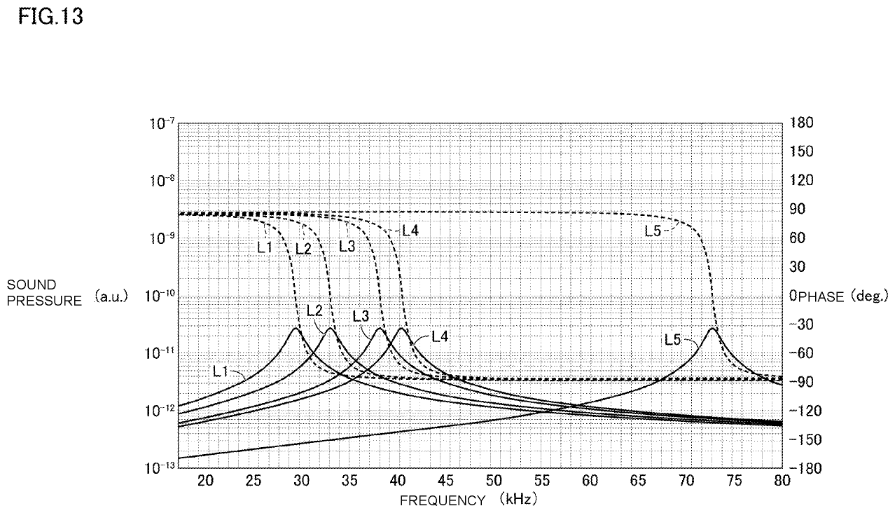

FIG. 13 is a graph illustrating the changes in sound pressure and phase with respect to frequency in the acoustic path of ultrasound emitted from a virtual sound source disposed at the location of the membrane portion. In some examples, without disposing the acoustic MEMS element 100, a virtual sound source that does not exhibit resonance was disposed at the position of the membrane portion 120, and the changes in sound pressure and phase with respect to frequency were simulated for five acoustic path samples with mutually different resonant frequencies.

In FIG. 13, the left vertical axis represents the sound pressure (a.u.) of the ultrasound, the right vertical axis represents the phase of the ultrasound (deg), and the horizontal axis represents the frequency of the ultrasound (kHz). The solid lines represent the sound pressure frequency characteristics, which are the changes in sound pressure with respect to the frequency of ultrasound, and the dotted lines represent the phase frequency response, which is the change in phase with respect to the frequency of ultrasound. L1 to L5 represent the data for samples 1 to 5, respectively.

As illustrated in FIG. 13, the sound pressure of the ultrasound emitted from sample 1 peaks at 32 kHz, which is the resonant frequency of the acoustic path P. The phase of the ultrasound emitted from sample 1 inverts at a frequency of 32 kHz. The sound pressure of the ultrasound emitted from sample 2 peaks at 35 kHz, which is the resonant frequency of the acoustic path P. The phase of the ultrasound emitted from sample 2 inverts at 35 kHz. The sound pressure of the ultrasound emitted from sample 3 peaks at 40 kHz, which is the resonant frequency of the acoustic path P. The phase of the ultrasound emitted from sample 3 inverts at a frequency of 40 kHz. The sound pressure of the ultrasound emitted from sample 4 peaks at 42 kHz, which is the resonant frequency of the acoustic path P. The phase of the ultrasound emitted from sample 4 inverts at a frequency of 42 kHz. The sound pressure of the ultrasound emitted from sample 5 peaks at 73 kHz, which is the resonant frequency of the acoustic path P. The phase of the ultrasound emitted from sample 5 inverts at a frequency of 73 kHz.

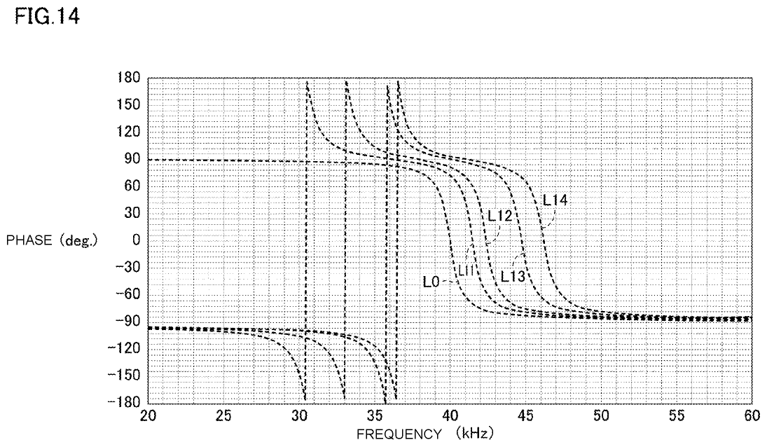

FIG. 14 is a graph illustrating changes in phase with respect to the frequency of ultrasound emitted from ultrasonic transducers, which are constructed by combining an acoustic MEMS element with the acoustic paths P of samples 1 to 4. In FIG. 14, the vertical axis represents the phase of the ultrasound (deg), and the horizontal axis represents the frequency of the ultrasound (kHz). L0 represents the phase-frequency characteristics of the acoustic MEMS element 100 alone, while L11 to L14 represent the phase-frequency characteristics of ultrasonic transducers, which are constructed by combining the acoustic MEMS element 100 with the acoustic paths P of samples 1 to 4.

As illustrated in FIG. 14, in ultrasonic transducers constructed by combining the acoustic MEMS element 100 with the acoustic paths P of samples 1 to 4, the frequency at which the phase of the emitted ultrasound inverts is shifted to a higher frequency compared to the case where only the acoustic MEMS element 100 is used. In other words, by using the acoustic MEMS element 100 in combination with the acoustic path P, the phase of the ultrasound emitted from the ultrasonic transducer can be stabilized when the frequency of the ultrasound is 40 kHz, which is the resonant frequency of the acoustic MEMS element 100. Furthermore, by changing the resonant frequency of the acoustic path P combined with the acoustic MEMS element 100, the frequency at which the phase of the ultrasound emitted from the ultrasonic transducer inverts can be adjusted.

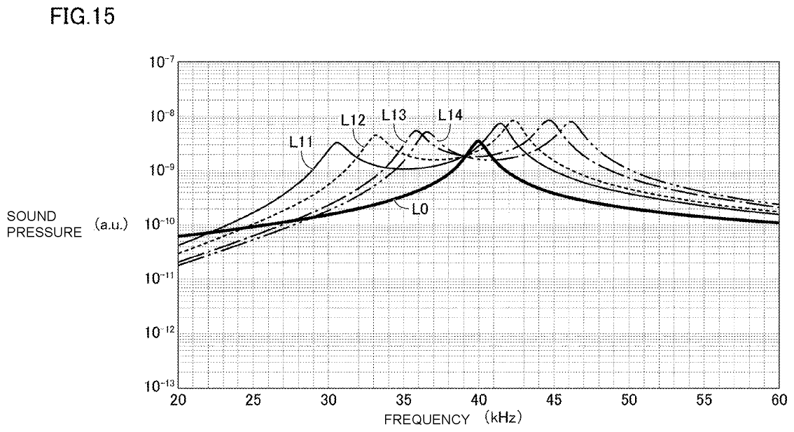

FIG. 15 is a graph illustrating the change in sound pressure with respect to frequency of ultrasound emitted from ultrasonic transducers, which are constructed by combining an acoustic MEMS element with the acoustic paths P of samples 1 to 4. In FIG. 15, the vertical axis represents the sound pressure (a.u.) of the ultrasound, and the horizontal axis represents the frequency (kHz) of the ultrasound. L0 represents the sound pressure frequency characteristics of the acoustic MEMS element 100 alone, while L11 to L14 represent the sound pressure frequency characteristics of ultrasonic transducers constructed by combining the acoustic MEMS element 100 with the acoustic paths P of samples 1 to 4.

As illustrated in FIG. 15, the ultrasonic transducers formed by combining the acoustic MEMS element 100 with the acoustic paths P of samples 1 to 4 have two sound pressure peaks. Note that two or more sound pressure peaks may be present. Thus, the combination of the resonance of the acoustic MEMS element 100 and the resonance in the acoustic paths P of samples 1 to 4 results in ultrasonic transducers having sound pressure frequency characteristics in which multiple sound pressure peaks appear. Compared to the case of the acoustic MEMS element 100 alone, the ultrasonic transducers formed by combining the acoustic paths P of samples 1 to 4 with the acoustic MEMS element 100 can emit high-sound-pressure ultrasound over a wider frequency band. Furthermore, by changing the resonant frequency of the acoustic path P combined with the acoustic MEMS element 100, the frequency at which a sound pressure peak of the ultrasound emitted from the ultrasonic transducer occurs can be adjusted.

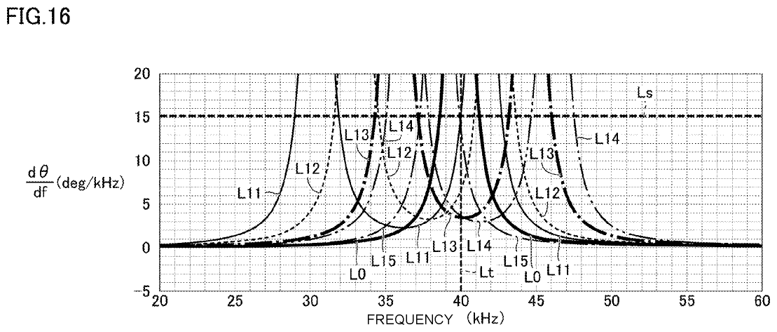

FIG. 16 is a graph illustrating the rate of change of phase θ with respect to frequency f in the phase frequency characteristics of ultrasound emitted from ultrasonic transducers constructed by combining a single acoustic MEMS element with the acoustic paths P of samples 1 to 5. In FIG. 16, the vertical axis represents dθ/df (deg/kHz), and the horizontal axis represents the frequency (kHz) of ultrasound. L0 represents the data for the phase frequency characteristics of the acoustic MEMS element 100 alone, while L11 to L15 represent the data for the phase frequency characteristics of ultrasonic transducers constructing by combining the acoustic MEMS element 100 with the acoustic paths P of samples 1 to 5.

In the phase-frequency characteristics of the ultrasound emitted from an ultrasonic transducer constructed by combining the acoustic MEMS element 100 with an acoustic path P, the allowable range of dθ/df (deg/kHz), which is the rate of change of phase θ with respect to frequency f, is 15 or less. When dθ/ df≤15 is satisfied, the Q value in the frequency band in which the ultrasonic transducer is used can be reduced, making it possible to emit ultrasound with a stable phase in that frequency band. Therefore, when the resonant frequency of the acoustic MEMS element 100 is 40 kHz, the resonant frequency of the acoustic path P needs to be set such that the intersection with a dotted line Lt illustrated in FIG. 16 is at or below a threshold of dθ/ df=15, indicated by a dotted line Ls.

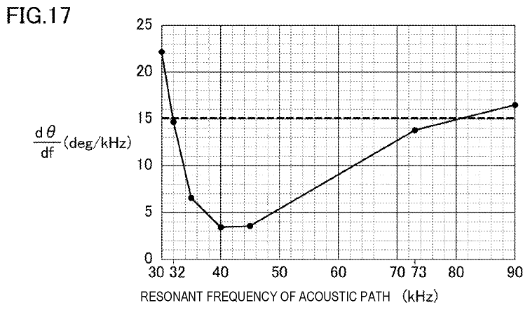

FIG. 17 is a graph illustrating the relationship between dθ/df and the resonant frequency of the acoustic path when the resonant frequency of the acoustic MEMS element is 40 kHz. In FIG. 17, the vertical axis represents dθ/ df (deg/kHz), and the horizontal axis represents the resonant frequency of the acoustic path P (kHz). In FIG. 17, the threshold value of dθ/df=15 is illustrated as a dotted line.

As illustrated in FIG. 17, when the resonant frequency of the acoustic MEMS element 100 was 40 kHz, the relationship dθ/df≤15 was satisfied when the resonant frequency of the acoustic path P was in the range greater than or equal to 32 kHz and less than or equal to 73 kHz.

Therefore, by satisfying the relationship −20≤(f1−f0)/f0×100≤80, where f0 is the resonant frequency of the acoustic MEMS element 100 and f1 is the resonant frequency of the acoustic path P, the Q value in the frequency band in which the ultrasonic transducer 200 is used can be reduced, and ultrasound with a stable phase in that frequency band can be emitted.

In the ultrasonic transducer 200 according to this exemplary embodiment, the acoustic path P consists of the opening 101 of the acoustic MEMS element 100 and the cavity 210h formed in the substrate 210 on which the acoustic MEMS element 100 is mounted. This allows the acoustic path P to be constructed with a simple configuration.

The cavity 210h penetrates through the substrate 210. This allows ultrasound to be emitted through the cavity 210h with high sound pressure.

The thickness H2 of the substrate 210 is greater than the shortest distance H1 from the substrate 210 to the membrane portion 120. Since the surface roughness of the substrate 210 in the cavity 210h is greater than the surface roughness of the substrate layer 15b in the opening 101, the relationship H2>H1 is satisfied, which increases the resistance of the ultrasound as it passes through the cavity 210h, and efficiently reduces the Q value of the ultrasound.

The cavity 210h has a cylindrical shape. When the thickness H2 of the substrate 210 is x (mm), the diameter W2 of the cavity 210h is y (mm), the density of air is ρ, acoustic velocity is c, the fluid viscosity of air is μ, and ω=2πf0, the radiation impedance when ultrasound is radiated from the cavity 210h to the outside is {ρc(ω/c)²/4π}, and the resistance when air passes through the cavity 210h, which can be determined from Poiseuille's law, is 128 μx/πy⁴.

In order to reduce the Q value of the acoustic path P to 80% or less, the resistance when air passes through the cavity 210h needs to be at least 0.25 times the radiation impedance. Therefore, the cavity 210h may be formed to satisfy the relationship {ρc(ω/c)²/4π}×0.25≤128 μx/πy⁴. For example, when the resonant frequency of the acoustic MEMS element 100 is 40 kHz and the diameter W2 of the cavity 210h is 0.6 mm, the thickness H2 of the substrate 210 is 0.8 mm or more. This also reduces the Q value in the frequency band in which the ultrasonic transducer 200 is used, making it possible to radiate ultrasound with a stable phase in that frequency band.

On the other hand, in order to ensure that the Q value of the acoustic path P is 10% or more so that the ultrasound output does not become too low, the resistance when air passes through cavity 210h must be less than or equal to 9 times the radiation impedance. Therefore, the cavity 210h may be formed so that the relationship {ρc(ω/c)²/4π}×0.25≤128 μx/πy⁴≤{ρc(ω/c)²/4π}×9 is satisfied.

In this exemplary embodiment, multiple acoustic MEMS elements 100 are disposed in an array on the substrate 210, and multiple cavities 210h are formed in the substrate 210 in a one-to-one correspondence with the multiple acoustic MEMS elements 100. As a result, the Q value of the ultrasound emitted from each of the multiple acoustic MEMS elements 100 is reduced in the frequency band used by the ultrasonic transducer 200, thereby stabilizing the phase in that frequency band. This allows for the stable superposition of ultrasound emitted from the multiple acoustic MEMS elements 100, enabling the emission of ultrasound with high sound pressure.

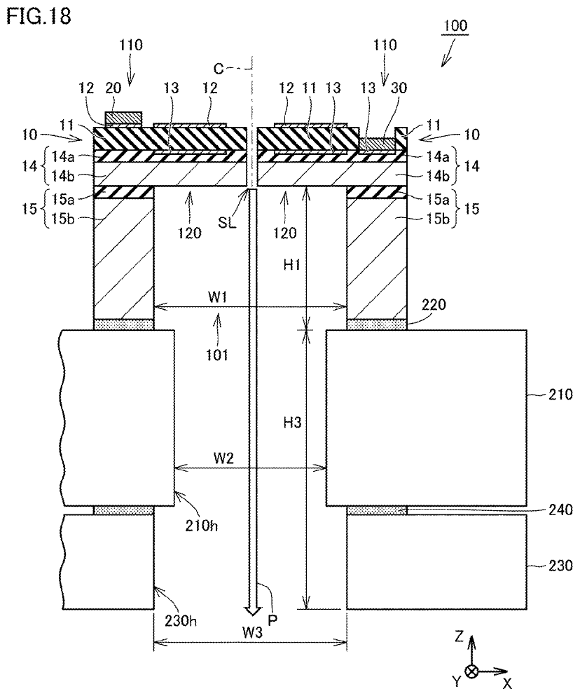

FIG. 18 is a cross-sectional view illustrating an ultrasonic transducer of a First Modification of Exemplary Embodiment 1 in which a cavity constituting an acoustic path is formed in a plurality of stacked substrates. As illustrated in FIG. 18, in the ultrasonic transducer according to the First Modification of Exemplary Embodiment 1, the substrate 210 is joined to a substrate 230 by adhesive 240 at the main surface of the substrate 210 on the opposite side from the main surface on which the acoustic MEMS element 100 is mounted. A cavity 230h is formed in the substrate 230 at a position corresponding to the cavity 210h. The cavity 230h is a hole that penetrates through the substrate 230. The cavity 230h has a cylindrical shape. However, the cavity 230h is not limited to a cylindrical shape, and may have a rectangular parallelepiped shape or the like. A diameter W3 of the cavity 230h is larger than the diameter W2 of the cavity 210h. However, the diameter W3 of the cavity 230h may be smaller than the diameter W2 of the cavity 210h.

A shortest distance H3 from the main surface of the substrate 210 on which the acoustic MEMS element 100 is mounted to the main surface of substrate 230 on the opposite side from the substrate 210 is greater than the shortest distance H1 from the substrate 210 to the membrane portion 120. In other words, when a cavity is formed across multiple stacked substrates, a substrate thickness x is the sum of the thicknesses of the multiple substrates and the thickness of the adhesive.

In the ultrasonic transducer according to the First Modification of Exemplary Embodiment 1 as well, the Q value in the frequency band in which the ultrasonic transducer is used can be reduced, making it possible to emit ultrasound with a stable phase in that frequency band.

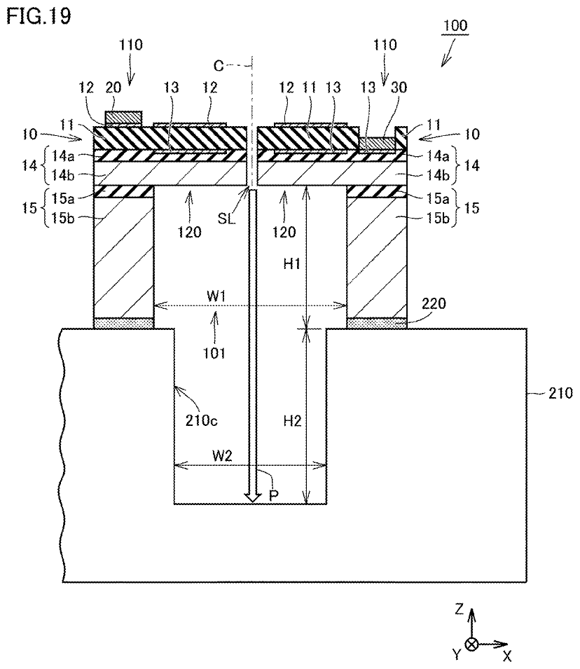

FIG. 19 is a cross-sectional view illustrating an ultrasonic transducer of a Second Modification of Exemplary Embodiment 1 in which the cavity constituting the acoustic path does not penetrate through the substrate. As illustrated in FIG. 19, in the ultrasonic transducer according to the Second Modification of Exemplary Embodiment 1, a cavity 210c is formed in the substrate 210. The cavity 210c does not penetrate through the substrate 210. Because the cavity 210c does not penetrate through the substrate 210, it is possible to suppress the intrusion of foreign matter into the acoustic path P.

In the ultrasonic transducer according to the Second Modification of Exemplary Embodiment 1 as well, the Q value in the frequency band in which the ultrasonic transducer is used can be reduced, making it possible to emit ultrasound with a stable phase in that frequency band.

### Exemplary Embodiment 2

An ultrasonic transducer according to Exemplary Embodiment 2 of the present disclosure will now be described with reference to the drawings. Note that the ultrasonic transducer according to Exemplary Embodiment 2 differs from the ultrasonic transducer according to Exemplary Embodiment 1 in that a single cavity is formed that corresponds to multiple acoustic MEMS elements. Therefore, description of parts of the configuration that are substantially the same as in the ultrasonic transducer according to Exemplary Embodiment 1 will not be repeated.

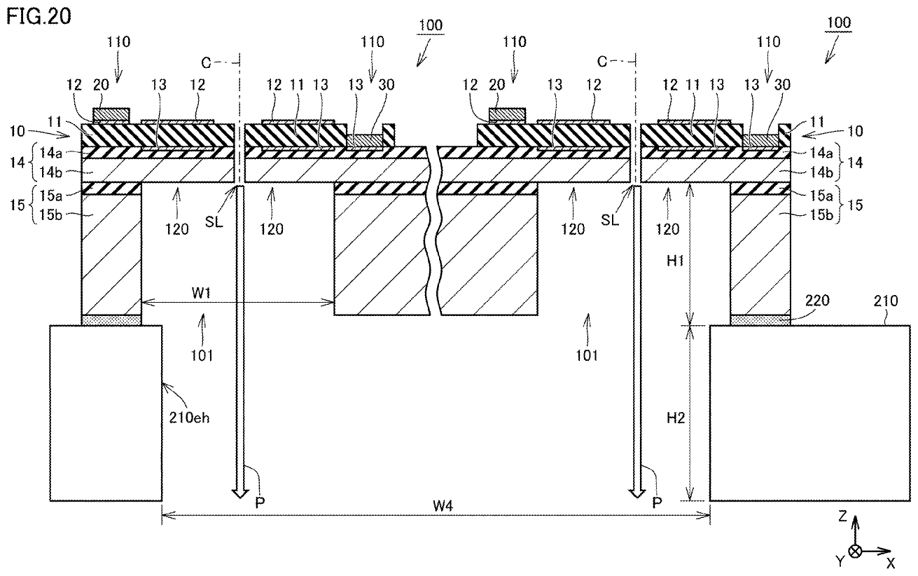

FIG. 20 is a cross-sectional view illustrating an ultrasonic transducer according to Exemplary Embodiment 2 of the present disclosure. As illustrated in FIG. 20, in the ultrasonic transducer according to Exemplary Embodiment 2 of the present disclosure, a plurality of acoustic MEMS elements 100 are disposed in an array on the substrate 210. At least one cavity 210eh is formed in the substrate 210 such that one cavity 210eh faces at least two acoustic MEMS elements 100 among the plurality of acoustic MEMS elements 100.

In this exemplary embodiment, one cavity 210eh is formed in the substrate 210. The one cavity 210eh faces four acoustic MEMS elements 100. The cavity 210eh is a hole that penetrates through the substrate 210. The cavity 210eh has a cylindrical shape with a diameter W4. However, the cavity 210eh is not limited to having a cylindrical shape, and may have a rectangular parallelepiped shape or the like. The thickness H2 of the substrate 210 is greater than the shortest distance H1 from the substrate 210 to the membrane portion 120.

In the ultrasonic transducer according to Exemplary Embodiment 2 as well, by combining the acoustic MEMS element 100 with the acoustic path P, the Q value in the frequency band in which the ultrasonic transducer is used can be reduced, making it possible to emit ultrasound with a stable phase in that frequency band.

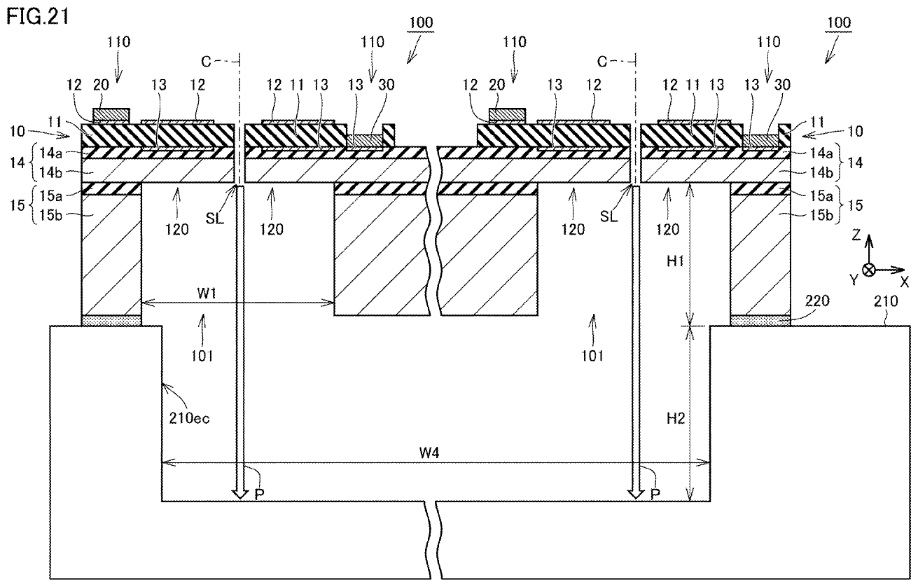

FIG. 21 is a cross-sectional view illustrating an ultrasonic transducer of a modification of Exemplary Embodiment 2 in which the cavity constituting the acoustic path does not penetrate through the substrate. As illustrated in FIG. 21, in the ultrasonic transducer according to the modification of Exemplary Embodiment 2, a cavity 210ec is formed in the substrate 210. The cavity 210ec does not penetrate through the substrate 210. Because the cavity 210ec does not penetrate through the substrate 210, it is possible to suppress the intrusion of foreign matter into the acoustic path P.

In the ultrasonic transducer according to the modification of Exemplary Embodiment 2 as well, the Q value in the frequency band in which the ultrasonic transducer is used can be reduced, making it possible to emit ultrasound with a stable phase in that frequency band.

### Appendices

Those skilled in the art will understand that the exemplary embodiments described above are specific examples of the following exemplary embodiments.

1. An ultrasonic transducer, comprising:
an acoustic micro electro mechanical system (MEMS) element; and
an acoustic path that is coupled with the acoustic MEMS element and is configured to resonate ultrasound generated by vibration of the acoustic MEMS element,
wherein:
sound pressure frequency characteristics of the ultrasonic transducer include multiple sound pressure peaks; and
a first resonant frequency of the acoustic MEMS element (f0) and a second resonant frequency of the acoustic path (f1) satisfy a relationship of:
−20≤(f1−f0)/f0×100≤80.

2. The ultrasonic transducer according to claim 1, further comprising:
a substrate on which the acoustic MEMS element is mounted,
wherein:
the substrate comprises a cavity at a position opposite the acoustic MEMS element.

3. The ultrasonic transducer according to claim 2, wherein:
the cavity has a cylindrical shape; and
a thickness of the substrate (x) and a diameter of the cavity (y) satisfy a relationship of:
{ρc(ω/c)²/4π}×0.25≤128 μx/πy⁴≤{ρc(ω/c)²/4π}×9, ρ representing density of air, c representing acoustic velocity, μ representing fluid viscosity of air, and ω representing 2πf0.

4. The ultrasonic transducer according to claim 2, wherein:
the acoustic MEMS element includes a base portion and a membrane portion, and
a thickness of the substrate is greater than a shortest distance from the substrate to the membrane portion.

5. The ultrasonic transducer according to claim 2, wherein the cavity penetrates through the substrate.

6. The ultrasonic transducer according to claim 2, wherein:
the acoustic MEMS element is one of a plurality of acoustic MEMS elements that are disposed in an array on the substrate, and
the substrate comprises a plurality of cavities that are at respective positions opposite the plurality of acoustic MEMS elements.

7. The ultrasonic transducer according to claim 2, wherein:
the acoustic MEMS element is one of a plurality of acoustic MEMS elements that are disposed in an array on the substrate, and
the substrate comprises at least one cavity that is at a position opposite at least two acoustic MEMS elements among the plurality of acoustic MEMS elements.

8. The ultrasonic transducer according to claim 2, wherein the substrate is a first substrate in a substrate stack that includes a plurality of substrates.

9. The ultrasonic transducer according to claim 8, wherein the cavity penetrates through the plurality of substrates.

10. The ultrasonic transducer according to claim 8, wherein the cavity does not penetrate at least one of the plurality of substrates.

11. An ultrasonic transducer, comprising:
a substrate; and
an acoustic micro electro mechanical system (MEMS) element that is mounted on the substrate,
wherein:
the substrate comprises a cavity at a position opposite the acoustic MEMS element to form an acoustic path to resonate ultrasound generated by vibration of the acoustic MEMS element, and
a first resonant frequency of the acoustic MEMS element (f0) and a second resonant frequency of the acoustic path (f1) satisfy a relationship of:
−20≤(f1−f0)/f0×100≤80.

12. The ultrasonic transducer according to claim 11, wherein:
the cavity has a cylindrical shape; and
a thickness of the substrate (x) and a diameter of the cavity (y) satisfy a relationship of:
{ρc(ω/c)²/4π}×0.25≤128 μx/πy⁴≤{ρc(ω/c)²/4π}×9, ρ representing density of air, c representing acoustic velocity, μ representing fluid viscosity of air, and ω representing 2πf0.

13. The ultrasonic transducer according to claim 11, wherein:
the acoustic MEMS element includes a base portion and a membrane portion, and
a thickness of the substrate is greater than a shortest distance from the substrate to the membrane portion.

14. The ultrasonic transducer according to claim 11, wherein the cavity penetrates through the substrate.

15. The ultrasonic transducer according to claim 11, wherein:
the acoustic MEMS element is one of a plurality of acoustic MEMS elements that are disposed in an array on the substrate, and
the substrate comprises a plurality of cavities that are at respective positions opposite the plurality of acoustic MEMS elements.

16. The ultrasonic transducer according to claim 11, wherein:
the acoustic MEMS element is one of a plurality of acoustic MEMS elements that are disposed in an array on the substrate, and
the substrate comprises at least one cavity that is at a position opposite at least two acoustic MEMS elements among the plurality of acoustic MEMS elements.

17. The ultrasonic transducer according to claim 11, wherein the substrate is a first substrate in a substrate stack that includes a plurality of substrates.

18. The ultrasonic transducer according to claim 17, wherein the cavity penetrates through the plurality of substrates.

19. The ultrasonic transducer according to claim 17, wherein the cavity does not penetrate at least one of the plurality of substrates.

20. The ultrasonic transducer according to claim 11, wherein sound pressure frequency characteristics of the ultrasonic transducer include multiple sound pressure peaks.
